(19) United States
(12) Patent Application Publication
(10) Pub. No.: US 2025/0022645 A1
(43) Pub. Date: Jan. 16, 2025

(54) COIL COMPONENT

(71) Applicant: TDK Corporation, Tokyo (JP)

(72) Inventors: Tomohiro MORIKI, Tokyo (JP); Shoma KAJIKIYA, Tokyo (JP); Ryota UCHIYAMA, Tokyo (JP)

(73) Assignee: TDK Corporation, Tokyo (JP)

(21) Appl. No.: 18/770,768

(22) Filed: Jul. 12, 2024

(30) Foreign Application Priority Data
Jul. 14, 2023 (JP) 2023-115908

(51) Int. Cl. H01F 17/00; H01F 17/04; H01F 27/29

(52) U.S. Cl. CPC H01F 17/0006; H01F 17/04; H01F 27/29; H01F 2017/0073

(57) ABSTRACT

Disclosed herein is a coil component that includes a planar coil pattern having first and a second main surfaces opposite to each other, a first resin layer covering the first main surface of the coil pattern, and a magnetic body covering the second main surface of the coil pattern. The coil pattern includes a terminal part positioned at an end thereof. The first resin layer has a first opening at a part of the terminal part. The magnetic body has a second opening at a part of the terminal part. The first main surface of the terminal part has a first part overlapping the first opening and a second part covered with the first resin layer. The second main surface of the terminal part has a third part overlapping the second opening and a fourth part covered with the magnetic body.

### CROSS-REFERENCE TO RELATED APPLICATION

This application claims the benefit of Japanese Patent Application No. 2023-115908, filed on Jul. 14, 2023, the entire disclosure of which is incorporated by reference herein.

### BACKGROUND

The present disclosure relates to a coil component.

JP 2021-068841A discloses a coil component having a planar coil pattern electrically accessible from its front and back sides.

However, the coil component disclosed in JP 2021-068841A has such a problem that strength thereof may be insufficient at a terminal part positioned at the end portion of the coil pattern.

### SUMMARY

A coil component according to one embodiment of the present disclosure includes: a planar coil pattern having a first main surface and a second main surface opposite to the first main surface; a first resin layer covering the first main surface of the coil pattern; and a magnetic body covering the second main surface of the coil pattern, wherein the coil pattern includes a terminal part positioned at an end thereof, wherein the first resin layer has a first opening at a part of the terminal part that overlaps the first main surface, wherein the magnetic body has a second opening at a part of the terminal part that overlaps the second main surface, wherein the first main surface of the terminal part has a first part overlapping the first opening and a second part covered with the first resin layer, and wherein the second main surface of the terminal part has a third part overlapping the second opening and a fourth part covered with the magnetic body.

### BRIEF DESCRIPTION OF THE DRAWINGS

The above features and advantages of the present disclosure will be more apparent from the following description of certain preferred embodiments taken in conjunction with the accompanying drawings, in which:

FIGS. 1 and 2 are schematic plan views illustrating the outer appearance of a coil component 100 according to an embodiment of the present disclosure as viewed from opposite sides;

FIG. 3 is a schematic plan view showing the coil component 100 in a state where the magnetic body 30 is removed;

FIG. 4 is an enlarge view of an area C illustrated in FIG. 3;

FIG. 5 is a schematic cross-sectional view taken along the line D-D in FIG. 4;

FIG. 6 is a schematic cross-sectional view for explaining the structure of each member constituting the coil device 100 in more detail;

FIG. 7 shows a modification of the structure shown in FIG. 6;

FIG. 8 is an enlarged view of the terminal part 10A of the coil pattern 10 as viewed from the first main surface 11 side; and

FIG. 9 is an enlarged view of the terminal part 10A of the coil pattern 10 as viewed from the second main surface 12 side.

### DETAILED DESCRIPTION OF THE EMBODIMENTS

An object of the present disclosure is therefore to enhance strength at the terminal part of a coil component having a planar coil pattern electrically accessible from its front and back sides.

Some embodiments of the present disclosure will be explained below in detail with reference to the accompanying drawings.

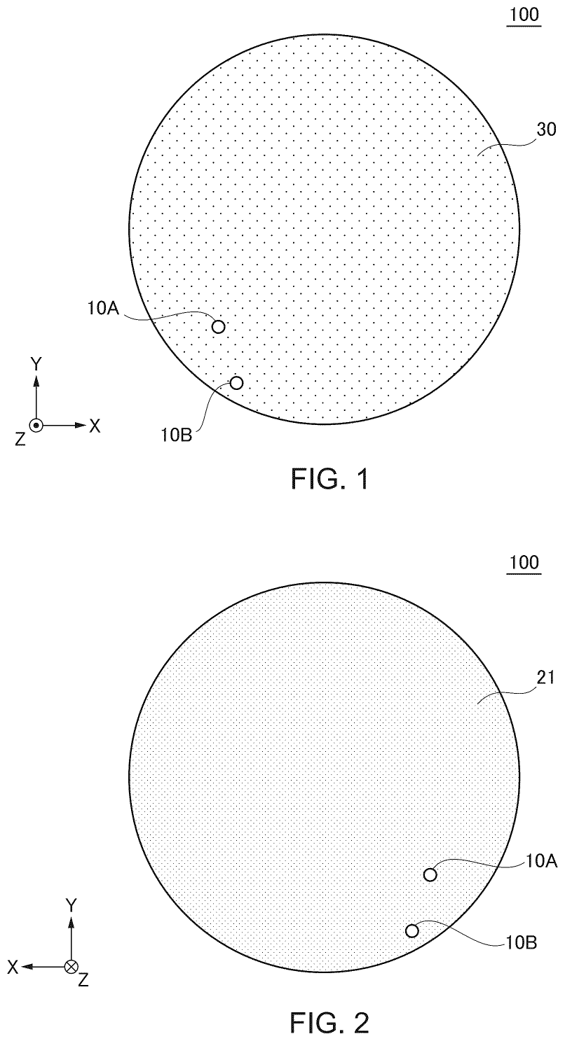

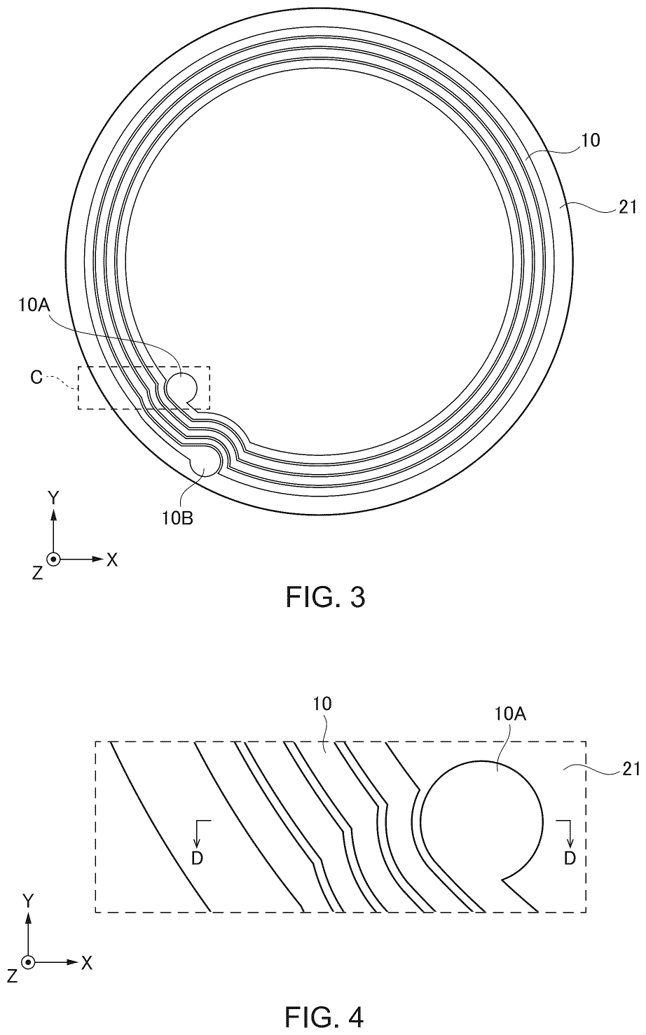

FIGS. 1 and 2 are schematic plan views illustrating the outer appearance of a coil component 100 according to an embodiment of the present disclosure as viewed from opposite sides.

As illustrated in FIGS. 1 and 2, the coil component 100 according to the present embodiment is formed into a substantially circular planar shape as viewed in the Z-direction and respectively has a magnetic body 30 and a first resin layer 21 on one surface and the other surface thereof. As illustrated in FIG. 3, which illustrates the coil component 100 from which the magnetic body 30 has been removed, a planar coil pattern 10 is provided between the magnetic body 30 and the first resin layer 21. In the example illustrated in FIG. 3, the coil pattern 10 is wound in about four turns creating a flat spiral. A terminal part 10A which is one end potion (inner peripheral end) of the coil pattern 10 and a terminal part 10B which is the other end portion (outer peripheral end) of the coil pattern 10 are each partially exposed to both surfaces of the coil component 100. This allows the coil component 100 according to the present embodiment to be electrically accessed from its front and back sides, thus improving mounting flexibility and use convenience. The planar shape of the coil component 100 as viewed in the Z-direction is not limited to a substantially circular shape but may be a substantially polygonal shape.

The planar shape of each of the terminal parts 10A and 10B is substantially circular, and the diameter thereof is larger than the pattern width of the area other than the terminal parts 10A and 10B of the coil pattern 10. The pattern width of the coil pattern 10 in the area other than the terminal parts 10A and 10B is almost constant at portions apart from the terminal parts 10A and 10B, while it is locally reduced at portions where the coil pattern 10 is wound along the terminal parts 10A and 10B. This can sufficiently ensure the area of the opening area surrounded by the coil pattern 10 while reducing the plane size of the entire coil component 100. That is, the terminal part 10A as the inner peripheral end is disposed so as to dig into the innermost turn, so that reduction in the area of the opening area due to the existence of the terminal part 10A can be suppressed. Further, the terminal part 10B as the outer peripheral end is disposed so as to dig into the outermost turn, so that an increase in the entire plane size of the entire coil component 100 due to the existence of the terminal part 10B can be suppressed. Furthermore, the pattern width of the coil pattern 10 is reduced at the portion where the terminal parts 10A and 10B dig into the outermost and innermost turns.

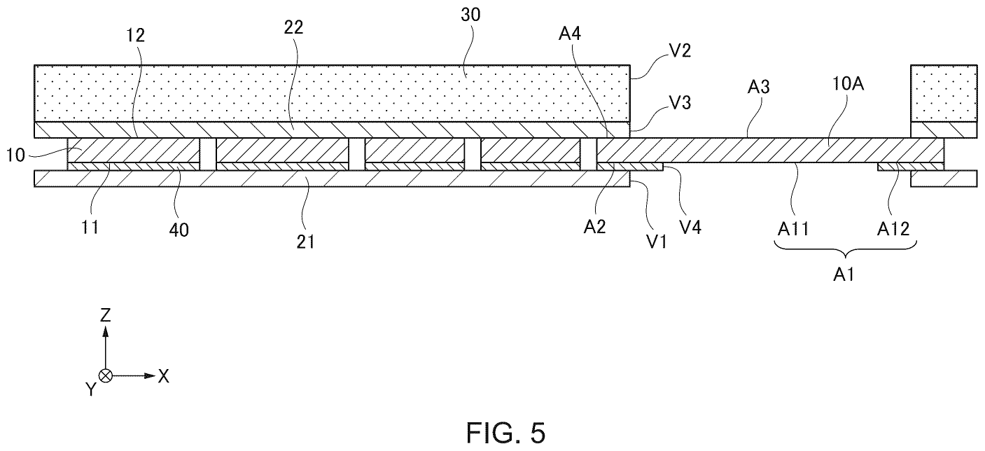

FIG. 4 is an enlarge view of an area C illustrated in FIG. 3. FIG. 5 is a schematic cross-sectional view taken along the line D-D in FIG. 4.

As illustrated in FIG. 4, in a part of the coil pattern 10 that is wound along the terminal part 10A, turns constituting the coil pattern 10 are largely bent so as to avoid the terminal part 10A, and turns closer to the inner periphery are bent more significantly (in other words, turns closer to the outer periphery are bent less, and the outermost turn is bent little with only the pattern width reduced as compared with other area thereof).

As illustrated in FIG. 5, the coil pattern 10 has a first main surface 11 constituting the XY surface and positioned at the negative Z-direction side and a second main surface 12 constituting the XY surface opposite to the first main surface 11 and positioned at the positive Z-direction side. The first main surface 11 of the coil pattern 10 is covered with the first resin layer 21 with a third resin layer 40 interposed therebetween except a part of each of the terminal parts 10A and 10B. The second main surface 12 of the coil pattern 10 is covered with the magnetic body 30 with a second resin layer 22 interposed therebetween except a part of each of the terminal parts 10A and 10B. Both sides of each of the first and second resin layers 21 and 22 may each have adhesiveness. The material of the first resin layer 21 is not particularly limited and may be an acrylic-based double-sided tape, for example. The material of the second resin layer 22 is not particularly limited, and examples thereof may include an acrylic-based double-sided tape and an acrylic binder resin. Alternatively, the second resin layer 22 may be formed of a material obtained by including a ceramic material in an acrylic-based binder resin. When both sides of the second resin layer 22 have adhesiveness, the coil pattern 10 and magnetic body 30 can be firmly stuck to each other through the second resin layer 22. When both sides of the first resin layer 21 have adhesiveness, the coil component 100 according to the present embodiment can be stuck to a mounting object, such as a circuit board, without separately using an adhesive. The material of the third resin layer 40 is not particularly limited, and examples thereof may include binder resin, including polyvinyl chloride-based resin, polycarbonate-based resin, polystyrene-based resin, polymethylmethacrylate-based resin, polyester-based resin, polysulfone-based resin, polyphenylene oxide-based resin, polybutadiene-based resin, poly (N-vinyl carobazole) based resin, hydrocarbon-based resin, ketone-based resin, phenoxy-based resin, polyamide-based resin, ethylcellulose-based resin, vinyl acetate-based resin, ABS-based resin, urethane-based resin, melanin-based resin, acrylic-based resin, unsaturated polyester-based resin, alkyd-based resin, epoxy-based resin, and silicon-based resin. The third resin layer 40 may be formed of a material obtained by including a conductive resin material in a binder resin.

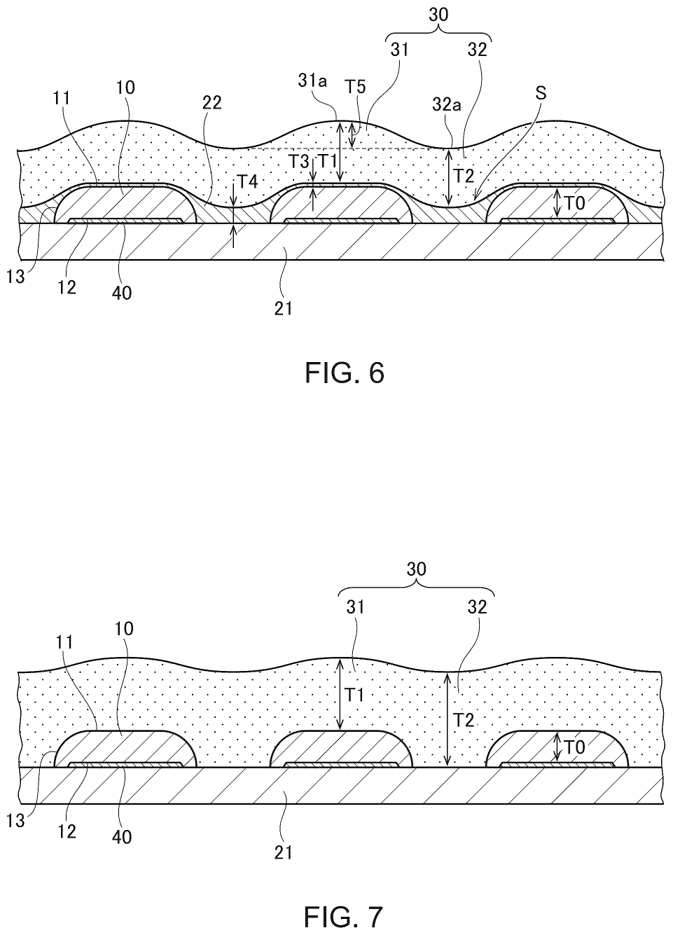

In the example illustrated in FIG. 5, the magnetic body 30 is formed of a magnetic sheet, and the first and second resin layers 21 and 22 are each formed of an acrylic-based double-sided tape. On the other hand, in the example illustrated in FIG. 6, the magnetic body 30 is formed of a magnetic sheet, the first resin layer 21 is formed of an acrylic-based double-sided tape, and the second resin layer 22 is formed of an acrylic-based binder resin. In the configuration illustrated in FIG. 6, the second resin layer 22 formed of an acrylic-based binder resin functions as a filling layer for a space area S positioned between turns of the coil pattern 10. In this case, the thickness of the second resin layer 22 is larger at a part (thickness T4) overlapping the space area S than at a part (thickness T3) overlapping the coil pattern 10. The thickness T4 of the second resin layer 22 positioned in the space area S may be smaller than a thickness TO of the coil pattern 10. With this configuration, at least a part of the side surface 13 of the coil pattern 10 that connects the first and second main surfaces 11 and 12 is covered with the magnetic body 30, so that higher magnetic characteristics can be achieved. The thickness T0 of the coil pattern 10 may be the sum of the thicknesses of the third resin layer 40 and coil pattern 10.

As illustrated in FIG. 6, the magnetic body 30 includes a first area 31 overlapping the coil pattern 10 and a second area 32 overlapping the area S positioned between of the coil pattern 10. A thickness T1 of the first area 31 may be almost the same as a thickness T2 of the second area 32. When the thicknesses T1 and T2 are almost the same, a height difference T5 between a surface 31a of the first area 31 and a surface 32a of the second area 32 is T4-T3, which is smaller than the thickness TO of the coil pattern 10. This can improve the flatness of the surface of the magnetic body 30. The thicknesses T1 and T2 of the magnetic body 30 may be larger than the thickness T0 of the coil pattern 10. This can achieve high magnetic characteristics. The height of the surface 31a of the first area 31 and the height of the surface 32a of the second area 32 each refer to the height with respect to the first resin layer 21.

Further, as another embodiment, the second resin layer 22 may be omitted as illustrated in FIG. 7. Other configurations are the same as those of the example illustrated in FIG. 6 (that is, the magnetic body 30 is formed of a magnetic sheet, and the first resin layer 21 is formed of an acrylic-based double-sided tape). In this configuration, the coil pattern 10 is directly covered with the magnetic body 30. Further, the entire side surface 13 of the coil pattern 10 is covered with the magnetic body 30, so that even higher magnetic characteristics can be achieved. In the example illustrated in FIG. 7, the thickness T2 of the second area 32 may be larger than the thickness T1 of the first area 31.

As illustrated in FIG. 5, the first resin layer 21 and the third resin layer 40 respectively have a first opening V1 and a fourth opening V4 at positions overlapping the first main surface 11 of the terminal part 10A. The magnetic body 30 and the second resin layer 22 respectively have a second opening V2 and a third opening V3 at positions overlapping the second main surface 12 of the terminal part 10A. With this configuration, the first main surface 11 of the terminal part 10A is partially exposed through the first and fourth openings V1 and V4. Similarly, the second main surface 12 of the terminal part 10A is partially exposed through the second and third openings V2 and V3. A surface treatment layer formed of Ni/Au plating or the like may be provided at the exposed portion of the terminal part 10A.

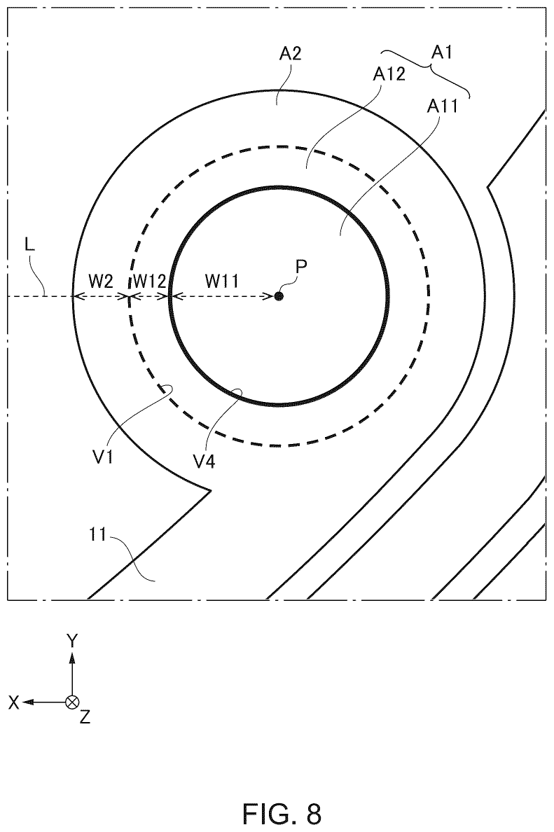

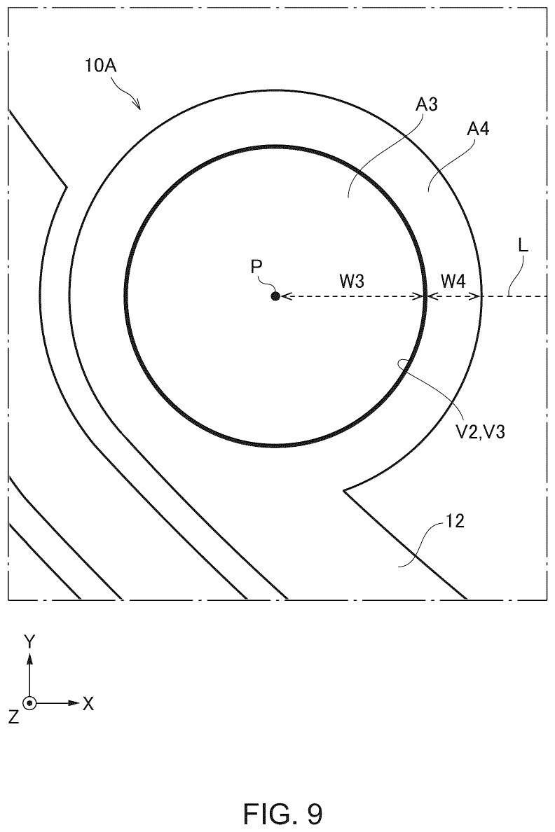

FIG. 8 is an enlarged view of the terminal part 10A of the coil pattern 10 as viewed from the first main surface 11 side.

As illustrated in FIG. 8, the first main surface 11 of the terminal part 10A has a first part A1 overlapping the first opening V1 of the first resin layer 21 and a second part A2 not overlapping the first opening V1 and covered with the first resin layer 21. The inner peripheral edge of the first opening V1 overlaps the first main surface 11 of the terminal part 10A over the entire periphery. In other words, the outer peripheral edge of the terminal part 10A at the first main surface 11 side is covered with the first resin layer 21 over the entire periphery. As a result, the outer peripheral edge of the terminal part 10A at the first main surface 11 side is not exposed through the first opening V1 but covered with the first resin layer 21. This prevents peeling of the terminal part 10A and enhances mechanical strength of the same.

Further, the inner peripheral edge of the fourth opening V4 of the third resin layer 40 overlaps the first part A1 of the terminal part 10A over the entire periphery. That is, the third resin layer 40 covers the inner peripheral edge of the first opening V1 over the entire periphery. As a result, the first part A1 of the terminal part 10A is partitioned into a first area A11 exposed through the fourth opening V4 and a second area A12 covered with the third resin layer 40. The first area A11 is an area where the terminal part 10A is exposed, and the second area A12 is an area where the third resin layer 40 is exposed. When a surface treatment layer formed of NiAu plating is provided at the terminal part 10A, it is formed at the first area A11 and not formed at the second area A12. This prevents a solder from flowing to the second area A12, increasing connection reliability.

Here, assuming that there is a virtual line L radially extending from a center P of the substantially circular terminal part 10A, a width W11 of the first area A11 along the virtual line L may be larger than a width W12 of the second area A12 along the virtual line L and a width W2 of the second part A2 along the virtual line L. With this configuration, the exposed area of the terminal part 10A at the first main surface 11 side can be sufficiently ensured. Further, the area of the first area A11 which is the exposed part of the terminal part 10A may be larger than the area of the second area A12, may be larger than the area of the second part A2, or may be larger than the sum of the areas of the second area A12 and second part A2.

FIG. 9 is an enlarged view of the terminal part 10A of the coil pattern 10 as viewed from the second main surface 12 side.

As illustrated in FIG. 9, the second main surface 12 of the terminal part 10A has a third part A3 overlapping the second opening V2 of the magnetic body 30 and the third opening V3 of the second resin layer 22 and a fourth part A4 not overlapping the second and third openings V2 and V3 and covered with the second resin layer 22 and magnetic body 30. The plane position of the inner peripheral edge of the second opening V2 and that of the inner peripheral edge of the third opening V3 may coincide with each other. The inner peripheral edges of the second and third openings V2 and V3 overlap the second main surface 12 of the terminal part 10A over the entire periphery. In other words, the outer peripheral edge of the terminal part 10A at the second main surface 12 side is covered with the second resin layer 22 and magnetic body 30 over the entire periphery. As a result, the outer peripheral edge of the terminal part 10A at the second main surface 12 side is not exposed through the second and third openings V2 and V3 but covered with the second resin layer 22 and magnetic body 30. This prevents peeling of the terminal part 10A and enhances mechanical strength of the same.

Here, assuming that there is a virtual line L radially extending from the center P of the substantially circular terminal part 10A, a width W3 of the third part A3 along the virtual line L may be larger than a width W4 of the fourth part A4 along the virtual line L. With this configuration, the exposed area of the terminal part 10A at the second main surface 12 side can be sufficiently ensured. Further, the area of the third part A3 which is the exposed part of the terminal part 10A may be larger than the area of the fourth part A4.

While the structures of the terminal part 10A of the coil pattern 10 and its peripheral portion have been described in detail, the terminal part 10B of the coil pattern 10 and its peripheral portion have the same configuration.

As described above, the coil component 100 according to the present embodiment has a disk shape with the XY surface as a main surface and allows connection to the coil pattern 10 from both sides in the Z-direction, thus improving mounting flexibility and use convenience. In addition, the terminal parts 10A and 10B positioned at both ends of the coil pattern 10 are designed such that their outer peripheral edges are not exposed but sandwiched in the Z-direction between the first resin layer 21 and the magnetic body 30, so that even when the thickness of the coil component 100 in the Z-direction is small, the mechanical strength of the terminal parts 10A and 10B can be sufficiently ensured.

While the preferred embodiment of the present disclosure has been described, the present disclosure is not limited to the above embodiment, and various modifications may be made within the scope of the present disclosure, and all such modifications are included in the present disclosure.

For example, the first resin layer 21 and coil pattern 10 need not directly contact each other, and a substrate formed of a PET film of the like may be interposed therebetween. In this case, the PET film or the like is removed at a position covering the terminal part 10A.

Further, in the examples illustrated in FIGS. 6 and 7, processing for eliminating a level difference in the surface of the magnetic body 30 may be performed upon formation of the magnetic body 30 so as to enhance the flatness of the surface of the magnetic body 30.

The technology according to the present disclosure includes the following configuration examples but not limited thereto.

A coil component according to an aspect of the present disclosure includes: a planar coil pattern having a first main surface and a second main surface opposite to the first main surface; a first resin layer covering the first main surface of the coil pattern; and a magnetic body covering the second main surface of the coil pattern. The coil pattern includes a terminal part positioned at the end thereof. The first resin layer has a first opening at a part of the terminal part that overlaps the first main surface. The magnetic body has a second opening at a part of the terminal part that overlaps the second main surface. The first main surface of the terminal part has a first part overlapping the first opening and a second part covered with the first resin layer. The second main surface of the terminal part has a third part overlapping the second opening and a fourth part covered with the magnetic body. With this configuration, it is possible to allow the coil component to be electrically accessible from its front and back sides while sufficiently ensuring the mechanical strength of the terminal part.

In the above coil component, the coil pattern may further have a side surface connecting the first and second main surfaces, and the magnetic body may cover at least a part of the side surface of the coil pattern. This can achieve high magnetic characteristics.

In the above coil component, the magnetic body may include a first area overlapping the coil pattern and a second area overlapping a space area positioned between turns of the coil pattern, and a height difference between the surface of the first area and the surface of the second area may be smaller than the thickness of the coil pattern. This can improve the flatness of the surface of the magnetic body.

The above coil component may further include a second resin layer positioned between the second main surface of the coil pattern and the magnetic body, and the second resin layer may have a third opening overlapping the second opening. This allows electrical connection to the second main surface of the terminal part through the second and third openings.

In the above coil component, both sides of each of the first and second resin layers may have adhesiveness. This allows the coil component to be stuck to a mounting object, such as a circuit board.

In the above coil component, the inner peripheral edge of the first opening may overlap the first main surface of the terminal part over the entire periphery, and the inner peripheral edge of the second opening may overlap the second main surface of the terminal part over the entire periphery. This can further enhance the mechanical strength of the terminal part.

The above coil component may further include a third resin layer which is positioned between the first main surface of the coil pattern and the first resin layer and covers the inner peripheral edge of the first opening, and the third resin layer may have a fourth opening exposing the first part therethrough. This allows electrical connection to the first main surface of the terminal part through the first and fourth openings.

In the above coil component, the first part may have a first area exposed through the fourth opening and a second area covered with the third resin layer, and the width of the first area along a virtual line radially extending from the center of the terminal part may be larger than the width of the second area along the virtual line. This can sufficiently ensure the exposed area of the terminal part at the first main surface side.

In the above coil component, the coil pattern may be spirally wound in a plurality of turns, and the pattern width of the coil pattern may be locally reduced at a portion wound along the terminal part. This achieves high inductance and makes it possible to sufficiently ensure the area of an opening area surrounded by the coil pattern while reducing the plane size of the entire coil component.

What is claimed is:

1. A coil component comprising:
a planar coil pattern having a first main surface and a second main surface opposite to the first main surface;
a first resin layer covering the first main surface of the coil pattern; and
a magnetic body covering the second main surface of the coil pattern,
wherein the coil pattern includes a terminal part positioned at an end thereof,
wherein the first resin layer has a first opening at a part of the terminal part that overlaps the first main surface,
wherein the magnetic body has a second opening at a part of the terminal part that overlaps the second main surface,
wherein the first main surface of the terminal part has a first part overlapping the first opening and a second part covered with the first resin layer, and
wherein the second main surface of the terminal part has a third part overlapping the second opening and a fourth part covered with the magnetic body.

2. The coil component as claimed in claim 1,
wherein the coil pattern further has a side surface connecting the first and second main surfaces, and
wherein the magnetic body covers at least a part of the side surface of the coil pattern.

3. The coil component as claimed in claim 2,
wherein the magnetic body includes a first area overlapping the coil pattern and a second area overlapping a space area positioned between turns of the coil pattern, and
wherein a height difference between a surface of the first area and a surface of the second area is smaller than a thickness of the coil pattern.

4. The coil component as claimed in claim 1, further comprising a second resin layer positioned between the second main surface of the coil pattern and the magnetic body,
wherein the second resin layer has a third opening overlapping the second opening.

5. The coil component as claimed in claim 4, wherein both sides of each of the first and second resin layers have adhesiveness.

6. The coil component as claimed in claim 1,
wherein an inner peripheral edge of the first opening overlaps the first main surface of the terminal part over an entire periphery, and
wherein an inner peripheral edge of the second opening overlaps the second main surface of the terminal part over an entire periphery.

7. The coil component as claimed in claim 6, further comprising a third resin layer which is positioned between the first main surface of the coil pattern and the first resin layer and covers the inner peripheral edge of the first opening,
wherein the third resin layer has a fourth opening exposing the first part therethrough.

8. The coil component as claimed in claim 7,
wherein the first part has a first area exposed through the fourth opening and a second area covered with the third resin layer, and
wherein a width of the first area along a virtual line radially extending from a center of the terminal part is larger than a width of the second area along the virtual line.

9. The coil component as claimed in claim 1,
wherein the coil pattern is spirally wound in a plurality of turns, and
wherein a pattern width of the coil pattern is locally reduced at a portion wound along the terminal part.
